(19) United States
(12) Patent Application Publication
(10) Pub. No.: US 2012/0005175 A1
(43) Pub. Date: Jan. 5, 2012

(54) METHOD AND A SYSTEM FOR REAL TIME REPLAYING OF DATABASE WORKLOAD AT A FIXED INITIAL TIME DELAY

(75) Inventor: Krishna VORA, Mumbai (IN)

(73) Assignee: EXACT SOLUTIONS, INC., New York, NY (US)

(21) Appl. No.: 13/173,374

(22) Filed: Jun. 30, 2011

(30) Foreign Application Priority Data
Jul. 2, 2010 (IN) 1936/MUM/2010

(51) Int. Cl. G06F 17/30

(52) U.S. Cl. 707/703; 707/E17.005

(57) ABSTRACT

A method to continuously replay Production Database Workload in near real time using workload capture based on Network or Kernel Capture is provided. The capture of the Server workload is done using Network Capture or using Kernel drivers in a continuous round robin method. The captured data is continuously pre-processed followed by a continuous replay of that data to a Test database system, with the replay lagging the original workload by a fixed initial time delay.

### REFERENCE TO RELATED APPLICATION AND CLAIM OF PRIORITY

This application claims the benefit of Indian Patent Application No. 1936/MUM/2010, filed on Jul. 2, 2010, the entire contents of which are incorporated herein by reference.

### FIELD OF THE INVENTION

The present invention relates to databases and more particularly relates to real time replay of database workloads onto a test database server at a fixed initial time delay with respect to the start of the original production workload.

### BACKGROUND

In large Enterprise Level Database installations, performance is critical. In addition, business conditions place pressure on extracting more performance with minimal expenses. To achieve more performance, installations/changes that are made to the databases are accurately assessed before implementation in the real time Production system. Changes could include, upgrading the database or modifying the database configurations and applications for tuning purposes. However, there is always a risk associated with large scale databases with performance degrades being the result of unplanned traffic surges or due to one or more application errors.

Traditional performance monitoring architectures focus Operating System and database internal metrics based alerting. The main disadvantage with such approaches is that the alerting happens always after the performance degrade which in most cases results in the reason for the degrade already having been lost.

Typical solutions were suggested by documents available in this area include U.S. Pat. No. 7,096,264 B2 granted to Bonney et al., U.S. Patent Publication No. 2005/0141432 filed by Mihai Sirbu, U.S. Patent Publication Nos. 2008/0097995 filed by Dias et al., and 2008/0097996 filed by Dias et al., contents of each of which is incorporated herein. However, no existing system replicates full scale Production Server traffic at a time delay 24×7. Therefore, there is a need for a method and a system to address the above identified problems so that any major production server performance degrades can be monitored later on a Test system with full concurrency.

Therefore, there arises a need for a system and a method that duplicating the Production Database Traffic to a Test Database with a fixed initial time delay so as to replicate any issues, with a delay, encountered on the Production system on to the Test system giving sufficient time for analysis and debugging thereby overcoming the problems existing in the art.

### OBJECTIVE OF THE INVENTION

The objective of the present invention is to provide a test system and a method implemented by the same that at least partly addresses the aforesaid lacunae.

The present invention seeks to satisfy the requirements for a solution which does not place any load on the production database and yet captures the complete workload with all the native complexity involved so as to continuously replay the workload at a fixed initial time delay onto a Test Database.

### SUMMARY OF THE INVENTION

Accordingly, the present invention provides a method for generating database transactions compatible for real time replaying of the transactions, said method comprising: capturing transactions occurring with respect to a source database server in the form of data packets transmitted to/received there from; grouping the data packets thus captured into one or more chunks; creating new round robin chunks from the one or more chunks of step (b), wherein new round robin chunks thus created contain packets that are time aligned and TCP aligned; and preprocessing the new round robin chunks of step (c) to generate database transactions compatible for real time replaying, said preprocessing is being performed based upon multiple configuration parameters selected from a group comprising Target server IP/Ports, Target server user passwords, Session Level Filters, Target Server Service Name, SSL Replay Session Level Filters, and Query Level Filters and database commit dependency.

Further, the present invention provides a method for replaying database transactions, said method comprising: re-mapping configuration and run time parameters of a target database server with the respective parameters of a source database server, said parameters include but not limited to Server capabilities, Login password, Server service name, SQL cursor IDs, Large Object (LOB) descriptors, ROWIDs; and reading and replaying chunks of preprocessed database transactions onto the target database server, wherein the said database transactions thus read and replayed are based on database transactions that occurred on the source database server and that have been grouped into chunks and then reordered based on TCP header/footer information and pre-processed based on multiple configuration parameters selected from a group comprising Target server IP/Ports, Target server user passwords, Session Level Filters, Target Server Service Name, SSL Replay Session Level Filters, and Query Level Filters and database commit dependency.

Furthermore, the present invention provides a method for real time replaying of database transactions, said method comprising capturing transactions occurring with respect to a source database server in the form of data packets transmitted to/received there from; grouping the data packets thus captured into one or more chunks; creating new round robin chunks from the one or more chunks of step (b), wherein new round robin chunks thus created contain packets that are time aligned and TCP aligned; and preprocessing the new round robin chunks of step (c) to generate database transactions compatible for real time replaying; and receiving the preprocessed transactions and replaying the transactions thus received onto a target database server; wherein the transactions thus captured and grouped into chunks are reordered based on TCP header/footer information; wherein the newly created round robin chunks are pre-processed based on multiple parameters selected from a group comprising Target server IP/Ports, Target server user passwords, Session Level Filters, Target Server Service Name, SSL Replay Session Level Filters, and Query Level Filters and database commit dependency to obtain transactions compatible for real time replaying.

Accordingly, the present invention provides a system for generating database transactions compatible for real time replaying of the transactions, said system comprising: an IO capturing sub-system, communicatively coupled with a source database server and being configured to capture transactions occurring with respect to a source database server in the form of data packets transmitted to/received there from; and group the data packets thus captured into one or more chunks; a TCP reordering sub-system, communicatively coupled with the IO capturing sub-system and being configured to create new round robin chunks from the one or more chunks created by the IO capturing sub-system, wherein new round robin chunks thus created contain packets that are time aligned and TCP aligned.

The system further comprising a pre-processing sub-system, communicatively coupled with the TCP reordering sub-system and being configured to preprocess the new round robin chunks thus created by the TCP reordering sub-system to generate database transactions compatible for real time replaying, said preprocessing is being performed based upon multiple configuration parameters selected from a group comprising Target server IP/Ports, Target server user passwords, Session Level Filters, Target Server Service Name, SSL Replay Session Level Filters, and Query Level Filters and database commit dependency.

Further, the present invention provides a system for real time replaying of database transactions, said system comprising: a re-mapping component, being configured to remap configuration and run time parameters of a target database server with the respective parameters of a source database server, said parameters include but not limited to Server capabilities, Login password, Server service name, SQL cursor IDs, Large Object (LOB) descriptors, ROWIDs; and a replay scheduler, being configured to read and replay chunks of preprocessed database transactions onto the target database server, wherein the said database transactions thus read and replayed by the replay scheduler are based on database transactions that occurred on the source database server and grouped into chunks by the IO capturing sub-system and that have been reordered by the TCP reordering sub-system based on TCP header/footer information and pre-processed by the pre-processing sub-system based on multiple configuration parameters selected from a group comprising Target server IP/Ports, Target server user passwords, Session Level Filters, Target Server Service Name, SSL Replay Session Level Filters, and Query Level Filters and database commit dependency.

Furthermore, the present invention provides a system for real time replaying of database transactions of a source database server onto a target database server, said system comprising: an IO capturing subsystem, communicatively coupled to the source database server and being configured capture transactions occurring with respect to a source database server in the form of data packets transmitted to/received there from and group the data packets thus captured into one or more chunks; a TCP reordering sub-system, communicatively coupled with the IO capturing sub-system and being configured to create new round robin chunks from the one or more chunks created by the IO capturing sub-system, wherein new round robin chunks thus created contain packets that are time aligned and TCP aligned; and a pre-processing sub-system, communicatively coupled with the TCP reordering sub-system and being configured to preprocess the new round robin chunks thus created by the TCP reordering sub-system to generate database transactions compatible for real time replaying.

The system further comprising a replay subsystem, communicatively coupled to the target database server and being configured to receive the preprocessed chunks from the said pre-processing subsystem and replay the preprocessed chunks thus received in real time; wherein the pre-processing sub-system is being configured to pre-process the newly created round robin chunks based on multiple parameters selected from a group comprising Target server IP/Ports, Target server user passwords, Session Level Filters, Target Server Service Name, SSL Replay Session Level Filters, and Query Level Filters and database commit dependency to obtain transactions compatible for real time replaying.

Accordingly, the present invention relates to a computer-readable medium comprising instructions, which, when executed by a computer system, cause the system to perform operations, the instructions comprising: capturing transactions occurring with respect to a source database server in the form of data packets transmitted to/received there from; grouping the data packets thus captured into one or more chunks; creating new round robin chunks from the one or more chunks of step (b), wherein new round robin chunks thus created contain packets that are time aligned and TCP aligned; and preprocessing the new round robin chunks of step (c) to generate database transactions compatible for real time replaying, said preprocessing is being performed based upon multiple configuration parameters selected from a group comprising Target server IP/Ports, Target server user passwords, Session Level Filters, Target Server Service Name, SSL Replay Session Level Filters, and Query Level Filters and database commit dependency.

Further, the present invention relates to a computer-readable medium comprising instructions, which, when executed by a computer system, cause the system to perform operations, the instructions comprising: re-mapping configuration and run time parameters of a target database server with the respective parameters of a source database server, said parameters include but not limited to Server capabilities, Login password, Server service name, SQL cursor IDs, Large Object (LOB) descriptors, ROWIDs; and reading and replaying chunks of preprocessed database transactions onto the target database server, wherein the said database transactions thus read and replayed are based on database transactions that occurred on the source database server and that have been grouped into chunks and then reordered based on TCP header/footer information and pre-processed based on multiple configuration parameters selected from a group comprising Target server IP/Ports, Target server user passwords, Session Level Filters, Target Server Service Name, SSL Replay Session Level Filters, and Query Level Filters and database commit dependency.

Furthermore, the present invention relates to a computer-readable medium comprising instructions, which, when executed by a computer system, cause the system to perform operations, the instructions comprising: capturing transactions occurring with respect to a source database server in the form of data packets transmitted to/received there from; grouping the data packets thus captured into one or more chunks; creating new round robin chunks from the one or more chunks of step (b), wherein new round robin chunks thus created contain packets that are time aligned and TCP aligned; and preprocessing the new round robin chunks of step (c) to generate database transactions compatible for real time replaying; and receiving the preprocessed transactions and replaying the transactions thus received onto a target database server; wherein the transactions thus captured and grouped into chunks are reordered based on TCP header/footer information; wherein the newly created round robin chunks are pre-processed based on multiple parameters selected from a group comprising Target server IP/Ports, Target server user passwords, Session Level Filters, Target Server Service Name, SSL Replay Session Level Filters, and Query Level Filters and database commit dependency to obtain transactions compatible for real time replaying.

### BRIEF DESCRIPTION OF THE DRAWINGS

The invention itself, together with further features and attended advantages, will become apparent from consideration of the following detailed description, taken in conjunction with the accompanying drawings. One or more embodiments of the present invention are now described, by way of example only, with reference to the accompanied drawings wherein like reference numerals represent like elements and in which:

FIG. 1 is a block diagram illustrating a system for capturing database workload and continuously replaying the same in accordance with an embodiment of the present invention.

FIG. 2 is a flow chart of a method for real time replaying of database workload in accordance with an embodiment of the present invention.

### DETAILED DESCRIPTION

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternative falling within the spirit and the scope of the invention.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present invention relates to a method for generating database transactions compatible for real time replaying of the transactions, said method comprising: capturing transactions occurring with respect to a source database server in the form of data packets transmitted to/received there from; grouping the data packets thus captured into one or more chunks; creating new round robin chunks from the one or more chunks of step (b), wherein new round robin chunks thus created contain packets that are time aligned and TCP aligned; and preprocessing the new round robin chunks of step (c) to generate database transactions compatible for real time replaying, said preprocessing is being performed based upon multiple configuration parameters selected from a group comprising Target server IP/Ports, Target server user passwords, Session Level Filters, arget Server Service Name, SSL Replay Session Level Filters, and Query Level Filters and database commit dependency.

In one aspect of the present invention, the step of creating new round robin chunks commences after the expiry of a first predetermined time period.

In another aspect of the present invention, the preprocessing of the newly created round robin chunks commences after the expiry of a second predetermined time period.

In yet another aspect of the present invention, the method further comprising cyclically performing the step of grouping the data packets such that the step of creating new round robin chunks commences after the expiry of a third predetermined time period.

In one aspect of the present invention, the method further comprising cyclically performing the step of creating new round robin chunks such that the step of preprocessing of the round robin chunks commences after the expiry of the third predetermined time period.

In another aspect of the present invention, the method further comprising cyclically performing the step of preprocessing of the round robin chunks as and when new round robin chunks are created.

Further, the present invention relates to a method for real time replaying of database transactions, said method comprising: re-mapping configuration and run time parameters of a target database server with the respective parameters of a source database server, said parameters include but not limited to Server capabilities, Login password, Server service name, SQL cursor IDs, Large Object (LOB) descriptors, ROWIDs; and reading and replaying chunks of preprocessed database transactions onto the target database server, wherein the said database transactions thus read and replayed are based on database transactions that occurred on the source database server and that have been grouped into chunks and then reordered based on TCP header/footer information and pre-processed based on multiple configuration parameters selected from a group comprising Target server IP/Ports, Target server user passwords, Session Level Filters, Target Server Service Name, SSL Replay Session Level Filters, and Query Level Filters and database commit dependency.

In one aspect of the present invention, the replaying of the preprocessed database transactions commences after the expiry of a fourth predetermined time period.

Furthermore, the present invention relates to a method for real time replaying of database transactions, said method comprising: capturing transactions occurring with respect to a source database server in the form of data packets transmitted to/received there from; grouping the data packets thus captured into one or more chunks; creating new round robin chunks from the one or more chunks of step (b), wherein new round robin chunks thus created contain packets that are time aligned and TCP aligned; and preprocessing the new round robin chunks of step (c) to generate database transactions compatible for real time replaying; and receiving the preprocessed transactions and replaying the transactions thus received onto a target database server; wherein the transactions thus captured and grouped into chunks are reordered based on TCP header/footer information; wherein the newly created round robin chunks are pre-processed based on multiple parameters selected from a group comprising Target server IP/Ports, Target server user passwords, Session Level Filters, Target Server Service Name, SSL Replay Session Level Filters, and Query Level Filters and database commit dependency to obtain transactions compatible for real time replaying.

In one aspect of the present invention, the step of creating new round robin chunks commences after the expiry of a first predetermined time period.

In another aspect of the present invention, the preprocessing of the newly created round robin chunks commences after the expiry of a second predetermined time period.

In one aspect of the present invention, the method further comprising cyclically performing the step of grouping the data packets such that the step of creating new round robin chunks commences after the expiry of a third predetermined time period.

In another aspect of the present invention, the method further comprising cyclically performing the step of creating new round robin chunks such that the step of preprocessing of the round robin chunks commences after the expiry of the third predetermined time period.

In yet another aspect of the present invention, the method further comprising cyclically performing the step of preprocessing of the round robin chunks as and when new round robin chunks are created.

In still another aspect of the present invention, the replaying of the preprocessed database transactions commences after the expiry of a fourth predetermined time period.

In one aspect of the present invention, the method further comprising: monitoring the performance of the target database server; and generating reports based on the comparison of performance of the source database server with the target database server.

Accordingly, the present invention relates to a system for generating database transactions compatible for real time replaying of the transactions, said system comprising: an IO capturing sub-system, communicatively coupled with a source database server and being configured to capture transactions occurring with respect to a source database server in the form of data packets transmitted to/received there from; and group the data packets thus captured into one or more chunks; a TCP reordering sub-system, communicatively coupled with the IO capturing sub-system and being configured to create new round robin chunks from the one or more chunks created by the IO capturing sub-system, wherein new round robin chunks thus created contain packets that are time aligned and TCP aligned; and a pre-processing sub-system, communicatively coupled with the TCP reordering sub-system and being configured to preprocess the new round robin chunks thus created by the TCP reordering sub-system to generate database transactions compatible for real time replaying, said preprocessing is being performed based upon multiple configuration parameters selected from a group comprising Target server IP/Ports, Target server user passwords, Session Level Filters, Target Server Service Name, SSL Replay Session Level Filters, and Query Level Filters and database commit dependency.

In one aspect of the present invention, the TCP reordering sub-system is configured to commence the creation of new round robin chunks after the expiry of a first predetermined time period.

In another aspect of the present invention, the pre-processing sub-system is configured to commence the preprocessing of the newly created round robin chunks after the expiry of a second predetermined time period.

In yet another aspect of the present invention, the IO capturing sub-system is further configured to cyclically perform the step of grouping the data packets such that the TCP reordering sub-system commences the step of creating new round robin chunks after the expiry of a third predetermined time period.

In one aspect of the present invention, the TCP reordering sub-system is further configured to cyclically perform the step of creating new round robin chunks such that the pre-processing sub-system commences the preprocessing of the round robin chunks after the expiry of the third predetermined time period.

In another aspect of the present invention, the pre-processing sub-system is further configured to cyclically perform preprocessing of the round robin chunks as and when the TCP reordering sub-system creates new round robin chunks.

Further, the present invention relates to a system for real time replaying of database transactions, said system comprising: a re-mapping component, being configured to remap configuration and run time parameters of a target database server with the respective parameters of a source database server, said parameters include but not limited to Server capabilities, Login password, Server service name, SQL cursor IDs, Large Object (LOB) descriptors, ROWIDs; and a replay scheduler, being configured to read and replay chunks of preprocessed database transactions onto the target database server, wherein the said database transactions thus read and replayed by the replay scheduler are based on database transactions that occurred on the source database server and grouped into chunks by the IO capturing sub-system and that have been reordered by the TCP reordering sub-system based on TCP header/footer information and pre-processed by the pre-processing sub-system based on multiple configuration parameters selected from a group comprising Target server IP/Ports, Target server user passwords, Session Level Filters, Target Server Service Name, SSL Replay Session Level Filters, and Query Level Filters and database commit dependency.

In one aspect of the present invention, the replay scheduler is configured to commence the replaying of the preprocessed database transactions after the expiry of a fourth predetermined time period.

Furthermore, the present invention relates to a system for real time replaying of database transactions of a source database server onto a target database server, said system comprising: an IO capturing subsystem, communicatively coupled to the source database server and being configured capture transactions occurring with respect to a source database server in the form of data packets transmitted to/received there from and group the data packets thus captured into one or more chunks; a TCP reordering sub-system, communicatively coupled with the IO capturing sub-system and being configured to create new round robin chunks from the one or more chunks created by the IO capturing sub-system, wherein new round robin chunks thus created contain packets that are time aligned and TCP aligned; and a pre-processing sub-system, communicatively coupled with the TCP reordering sub-system and being configured to preprocess the new round robin chunks thus created by the TCP reordering sub-system to generate database transactions compatible for real time replaying; and a replay subsystem, communicatively coupled to the target database server and being configured to receive the preprocessed chunks from the said pre-processing subsystem and replay the preprocessed chunks thus received in real time; wherein the pre-processing sub-system is being configured to pre-process the newly created round robin chunks based on multiple parameters selected from a group comprising Target server IP/Ports, Target server user passwords, Session Level Filters, Target Server Service Name, SSL Replay Session Level Filters, and Query Level Filters and database commit dependency to obtain transactions compatible for real time replaying.

In one aspect of the present invention, the system further comprising a Reporting subsystem configured to monitor the performance of the target database server and to generate a report based on comparison of the performance of the source database server and the target database server.

In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following description is, therefore, not to be taken in a limiting sense.

The present disclosure relates to a method and a system for continuous replay of production traffic of various databases such as Sybase™, DB2™, Informix™, etc., using a Production server network traffic capture or using Kernel Capture devices, in near real time at a fixed initial time delay as described below. Production workload capture implies capturing traffic to/from the Production Server. The term ‘IO Capture’ referred henceforth will imply either Network Traffic capture or Kernel based Capturing.

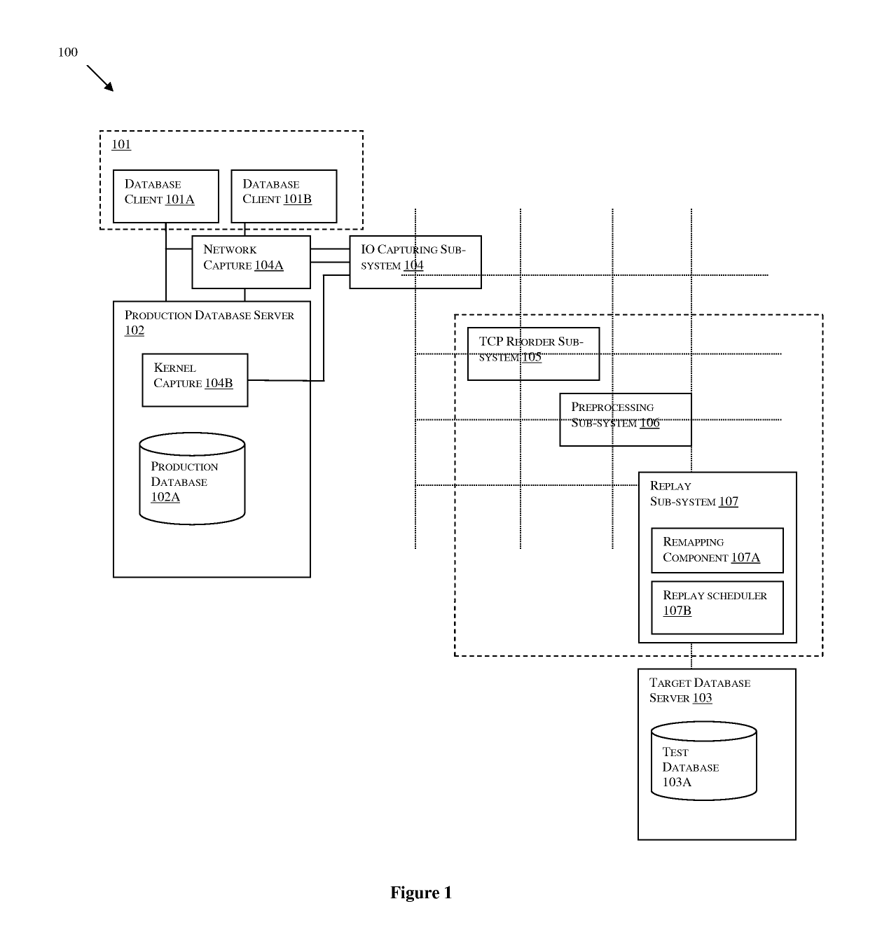

FIG. 1 is a block diagram illustrating a system for capturing database workload and continuously replaying the same in accordance with an embodiment of the present invention.

The system (100) as shown in FIG. 1 may be a dedicated set of hardware or merely a collection of resources from within one or more other systems. Further, the system has several components shown as separate entities, but may actually consists of several different functions of one entity, and any combination in between.

In one embodiment, the system (100) comprises of one or more database clients 101A, 101B . . . and so on (commonly referred to as database client 101) communicatively connected to a production/source database server (102) via a network. The system is configured to capture the workload on the source database server (102) and replay the same workload onto a target database server (103) to determine whether the difference between the performance of the source database server (102) and the target database server (103) is a permissible or desirable difference.

The database client (101) includes a desktop personal computer, workstation, laptop, PDA, cell phone, or any WAP-enabled device or any other computing device capable of interfacing directly or indirectly to the Internet or other network connection. The database client typically includes one or more user interface devices, such as a keyboard, a mouse, touch screen, pen or the like, for interacting with the GUI provided on a display. The database client also includes a graphical user interface (GUI) provided therein for interacting with the database server to access data and to view generated reports.

The network can be a LAN (local area network), WAN (wide area network), wireless network, point-to-point network, or other configuration. One of the most common types of network in current use is a TCP/IP (Transfer Control Protocol and Internet Protocol) network for communication between database client and database server. Other common Internet protocols used for such communication include HTTP, FTP, AFS, and WAP etc.

The source database server (102) includes a includes a desktop personal computer, workstation, laptop, PDA, cell phone, or any WAP-enabled device or any other computing device capable of interfacing directly or indirectly to the Internet or other network connection. The database server may include at least one processor with associated system memory, which may store, for example one or more databases. The system may further include additional memory, which may, for example, include instructions to perform various operations. The system memory and other memory may comprise separate memory devices, a single shared memory device or a combination of separate and shared memory devices. The database server typically includes one or more user interface devices, such as a keyboard, a mouse, touch screen, pen or the like, for interacting with the GUI provided on a display. The memory of the source database server includes a production database (102A) for storing transactions, and data related to transactions.

The target database server (103) also interchangeably referred to as test database server (103), includes a includes a desktop personal computer, workstation, laptop, PDA, cell phone, or any WAP-enabled device or any other computing device capable of interfacing directly or indirectly to the Internet or other network connection. The database server may include at least one processor with associated system memory, which may store, for example one or more databases. The system may further include additional memory, which may, for example, include instructions to perform various operations. The system memory and other memory may comprise separate memory devices, a single shared memory device or a combination of separate and shared memory devices. The database server typically includes one or more user interface devices, such as a keyboard, a mouse, touch screen, pen or the like, for interacting with the GUI provided on a display. The memory of the target database server includes a test database (103A) for storing transactions, and data related to transactions.

The target database server (103) may be different in one or more respects from production database server (102). In one embodiment, the test database server (103) might be an upgraded version of the production database server (102). In another embodiment, the test database server (103) may be the same brand and version of production database server (102), but the test database server (103) might be configured differently in one or more settings from the production database server (102). Test database server (103) might execute on a machine that has different hardware than the hardware of the machine on which production database server (102) executes. Test database server (103) might execute in conjunction with a different operating system than the operating system in conjunction with which production database server (102) executes. The purpose of subjecting test database server (103) to the same workload as that to which production database server (102) was actually subjected may be able to determine whether the difference between test database server (103) and production database server (102) and/or the difference in the environments in which those database servers execute is a permissible or desirable difference.

In one embodiment, there is one instance of the production database server and one instance of the test database server. However, in alternative embodiments of the invention, there may be multiple production database server instances, all of which perform database operations relative to production database 102A. Additionally, in alternative embodiments of the invention, there may be multiple test database server instances, all of which perform database relative to test database 103A. In one embodiment of the invention, the number of production database server instances differs from the number of test database server instances.

Test database (103A) may be different in one or more respects from production database (102A). For example, the manner in which logical relational database structures are physically laid out and stored on disk in test database (103A) might differ from the manner in such logical relational database structures are physically laid out and stored on disk in production database (102A). Thus, although the values present in the data that is stored in the production database (102A) will be the same as the values present in the data that is stored in the test database (103A), the manner in which those values are stored on disk may differ between the two databases. The purpose of subjecting test database server (103) to the same workload as that to which production database server (102) actually was subjected may be to determine whether the difference between test database (103A) and production database (102A) is a permissible or desirable difference. Typically, test database (103A) is not merely a backup, minor or fail-over of production database (102A).

Further, the system comprises an IO capturing subsystem (104), is a desktop personal computer, workstation, laptop, PDA, cell phone, or any WAP-enabled device or any other computing device capable of interfacing directly or indirectly to the Internet or other network connection. The IO capturing subsystem (104) typically includes one or more user interface devices, such as a keyboard, a mouse, touch screen, pen or the like, for interacting with the GUI provided on a display. The IO capturing subsystem is configured to capture the database workload of the production database server (102). The IO capturing subsystem is implemented as a standalone system or as a part of the production database server.

In one embodiment, the IO capturing subsystem (104) is a network capture device (104A) communicatively coupled with the database clients 101 being configured to capture the workload in the form of packets transmitted to/received from the source database server (102). For example, the network capture device (104A) is any Network capturing tools or Network taps existing in the art. The network capturing tools may reside in a remote host to capture the workload using Switch Port Mirroring for capturing and writing the transactions in a pcap Network capture format which is a open file format used by Network capture applications like ‘tcpdump’. In another embodiment, the IO capturing system is a Kernel Capture driver (104B) residing in the production database server. The Kernel Capture driver (104B) is configured to listen to the network traffic or Inter Process Communication (IPC) traffic. A user level application of the Kernel capture driver is configured to write the traffic thus captured into pcap network capture format.

The IO capturing subsystem (104) is further configured to group the captured packets into one or more chunks and stores the same in the pcap network format. The size of a chunk is based on either a maximum file size of the pcap file or a maximum time interval. These chunks are continuously sent to the replay system in real time.

The system (100) further comprises a TCP reordering subsystem (105) communicatively coupled with the IO capturing subsystem (103) and configured to reorder the chunks thus grouped by the IO capturing subsystem to obtain a new round robin chunks. The TCP reordering subsystem (105) is a desktop personal computer, workstation, laptop, PDA, cell phone, or any WAP-enabled device or any other computing device capable of interfacing directly or indirectly to the Internet or other network connection. The TCP reordering subsystem (105) typically includes one or more user interface devices, such as a keyboard, a mouse, touch screen, pen or the like, for interacting with the GUI provided on a display. The TCP reordering subsystem (105) is configured to create new round robin chunks of transactions that have been captured across multiple client connections and grouped into chunks based on TCP/IP information of the transactions such that the newly created round robin chunks has transactions that are time aligned and TCP aligned.

Further, the system (100) comprises a Pre-processing subsystem (106) which is communicatively coupled with the TCP reordering system (105). The pre-processing subsystem (106) is a desktop personal computer, workstation, laptop, PDA, cell phone, or any WAP-enabled device or any other computing device capable of interfacing directly or indirectly to the Internet or other network connection. The pre-processing subsystem (106) typically includes one or more user interface devices, such as a keyboard, a mouse, touch screen, pen or the like, for interacting with the GUI provided on a display. The pre-processing subsystem (106) is configured to analyze the transactions in the newly created round robin chunks based on multiple configuration parameters in order to obtain preprocessed transactions compatible for replaying.

The reordered transactions are then replayed by a replay system (107) communicatively coupled with the target or test database server (103). The replay subsystem (107) is a desktop personal computer, workstation, laptop, PDA, cell phone, or any WAP-enabled device or any other computing device capable of interfacing directly or indirectly to the Internet or other network connection. The replay subsystem (107) typically includes one or more user interface devices, such as a keyboard, a mouse, touch screen, pen or the like, for interacting with the GUI provided on a display.

The replay system (107) is configured to replay the preprocessed transactions in the same order as it was played to the source database server (102). The replay system (107) is also configured to validate the target Server Responses during the replay of Mainframe Database traffic onto non-Mainframe machines by reconciling the Character set differences encountered in the server responses, as Mainframes use a default character set of EBCDIC and non-Mainframe may use ASCII character set. In one embodiment, the replay system (107) further comprises a Character set mapping system configured to reconcile Character set differences during the replay of Mainframe database transactions onto a Non-Mainframe machine.

The system (100) optionally comprises a reporting system configured to monitor the performance of the test database server and generate reports for the same. The reporting system may be present within the target database server or may be present as a standalone system in a remote machine.

Typically Databases are restarted periodically say every fortnight or every month. The Test Database (103A) onto which the replay will take place needs to be restarted at the same time as when the Production Database (102A) is restarted. The test database (103A) is restored based on the last Production database backup and then restarted. The test database (103A) also needs to have its user passwords reset as per the supplied list of passwords to the Replay subsystem. The capture of the Production workload is started right after the Production Server (102) reset. The captured workload is grouped into one or more chunks of a predetermined size. The IO capturing system (104) is configured to continuously perform the capturing and grouping of the packets into chunks until the expiry of a predetermined time period say for example ‘T1’.

On expiry of the time period ‘T1’, the TCP reordering subsystem (105) begins the process of reordering the chunks so as to continuously create a new round robin chunks until the expiry of another predetermined time period say for example ‘T2’. Further, upon expiry of the time period ‘T2’, the pre-processing subsystem (106) begins the preprocessing of the round robin chunks i.e., analyzing the chunks, detecting commit dependency and creating data structures related to the preprocessed chunks thereby creating database transactions compatible for replaying.

The pre-processing subsystem (106) performs the step of preprocessing until the expiry of a predetermined time period ‘T3’. Following the expiry of the time period T3, the replay subsystem (107) replays the transactions thus preprocessed in real time. The replay to the test system (103) occurs at a fixed initial Time Delay (say ‘T4’ seconds). The completion of each of the above mentioned predetermined time periods can be achieved through configuring time using timer(s).

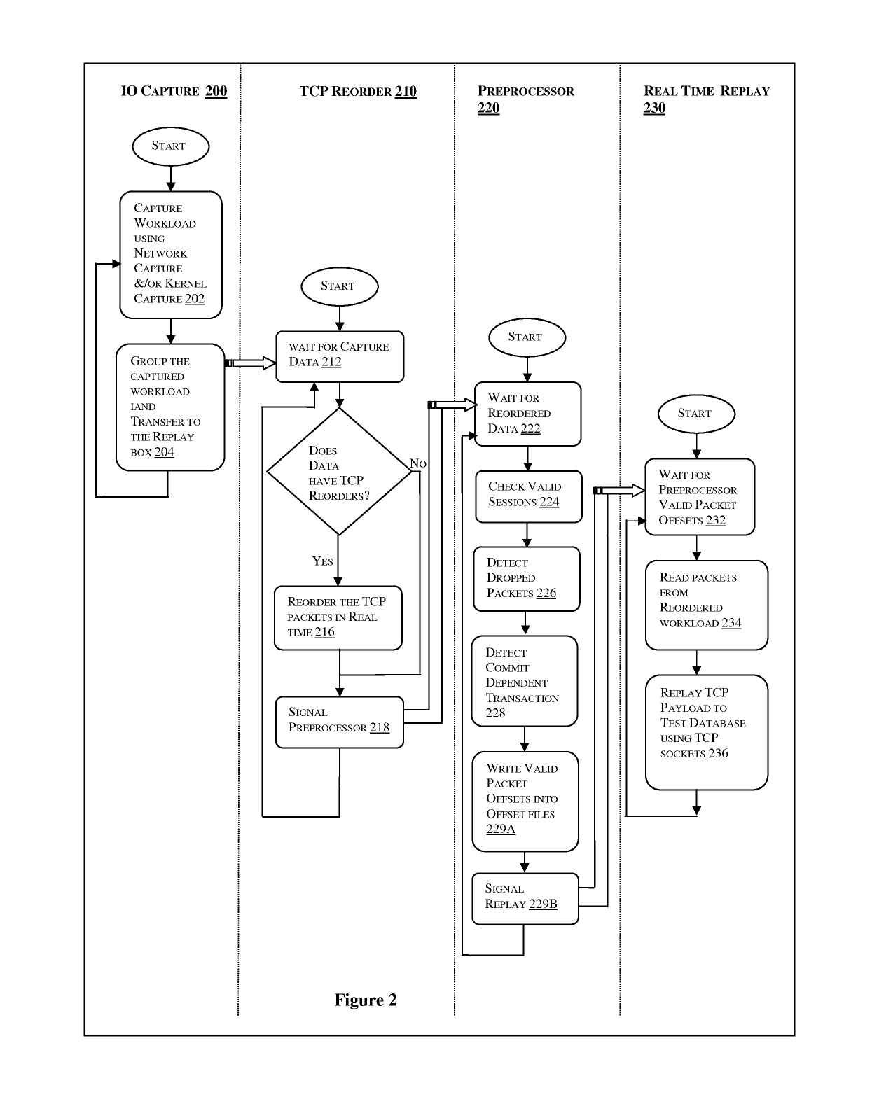

FIG. 2 is a flow chart of a method for real time replaying of database transactions in accordance with an embodiment of the present invention.

The flowchart, as shown in FIG. 2, relates to a method of real time replaying of production workload onto a test database server (103). The method for Replaying production scale traffic of various databases such as Sybase™, DB2™, Informix™, etc. with the source database server workload captured using network traffic capture or using Kernel Capture modules is described below. The method includes four stages such as IO capture (200), TCP Reorder (210), Preprocessor (220) and Real time Replay (230). Each of the stages is explained in detail in the following paragraphs.

At block (202), the method performs capturing of Source Database workload i.e., capturing traffic to/from the source database of the source database server (102). The term ‘IO Capture’ referred henceforth will imply either Network Traffic capture or Kernel based Capturing or both. The IO capturing subsystem captures the data transmitted from/received to the source database server (102) and groups the same into one or more chunks. The size of a chunk is based on either a maximum file size or a maximum time interval. These chunks are continuously sent to the Replay machine in near real time.

### Capturing (202) Production Workload Using Network Capture Device 104A

The method performs capturing of Source Database workload using Network Capture device 104A. In one embodiment, database Clients (101) typically connect to the Production Database Server (102) using TCP/IP protocol. The communication between the client(s) (101) and the server (102) is in the form of Network Packets. Each packet comprises workload/transactions of the source database server embedded as packets along with TCP/IP header/footer information. Workload/transactions includes for example, requests originating from one of the database clients (101), or one of the database servers, or some other process that is external to the production database server (102).

The communication channel traffic/workload can be captured using Network Capture device 104A. In one aspect, the communication channel traffic/workload is duplicated using Network Switch Port Mirrors (SPAN Ports) or using Network Taps (102C) and the duplicated traffic is routed to the capture device 104A. The capture device 104A includes a capture process which saves the Network Traffic in an open protocol ‘pcap’ file format onto disk. Typical Network capture tools (for e.g. ‘tcpdump’) use ‘pcap’ format to save the captured network traffic. The capture device can also be a dedicated Network Capture Appliance which uses Network Traffic ‘Stream to Disk’ technologies to capture very high traffic throughputs.

In case of using Network TAP or a Switch Port Minor, changes to the network configuration are required. In cases where such changes are not feasible, the Network Capture can take place directly on the Database host. In such a scenario, user may configure the capture to take place directly onto a local Disk File System on the production host itself, or use the facility of simultaneous capture and transfer, wherein, small chunks of production workload are captured and transferred to a remote host where real time amalgamation of the workload happens whilst the capture is going on. The local host capture process listens to Network Traffic on user specified Network Interface Cards or Loop back devices and writes the captured network traffic in chunks so as to optimize local disk writes.

The Capture process is Protocol Independent. The same Capture process can capture traffic from a variety of Databases such as Sybase™, DB2™, Informix™, etc. The Capture process records the entire TCP/IP transactions across multiple TCP Sessions. The captured data may not be completely time sorted. Also, in case of larger throughputs, the capture may have some packet drops.

In one embodiment, multiple Captures can also be initiated if it is not feasible to capture from one source only. In such a case, the TCP Reordering engine amalgamates distinct capture chunks based on time stamps.

The benefit of using Network Capture is that no Database connections need to be established for the purpose of the capture. Also, in case of Remote capture (using Switch Port Mirrors or Network Taps), the Database host experiences 0% load, since no part of the capturing occurs on the host. In case of Local capture, the lightweight capture process ensures that only 3-5% CPU utilization occurs.

### Capturing (202) Production Workload Using Kernel Capture Driver 104E

In another embodiment, a Network Capture (104A) based approach is not feasible for capturing the production workload. For example, in case the workload is being run on Operating Systems like Solaris or HPUX under loop back (i.e. where the traffic is initiated on the same machine as the database server). Under Solaris (upto Solaris version 10) and HPUX, loop back traffic capture cannot be used using network capture techniques and necessitates the use of dedicated Kernel modules and therefore, the workload is captured through Kernel Capture driver 104B. In some cases the traffic is so high that a Network capture based approach could result in significant packet drops warranting the use of a Kernel Module to minimize packet drops. Also, if the traffic is being sent, not using TCP/IP, but using Inter Process Communication (IPC), such as using Shared Memory (on UNIX based systems), a Network Capture will not be able to capture the workload.

Under such circumstances, the Production Workload capture is done using a Kernel Capture driver (104B). The Kernel capture driver (104B) will receive the traffic to/from the production database in the payload format itself, i.e. without the complete TCP or IP headers. The user space application interacting with the Kernel driver will prepend dummy Ethernet, IP and TCP headers to this payload. The user space application will also generate dummy TCP sequence numbers which would also take into consideration packet drops, if any, and write the payload in a pcap file format.

In one aspect, for Solaris or HPUX Kernel based capture, the Kernel capture driver (104B) is configured either between the TCP and IP Layers or between the TCP and Socket Layers. A local capture application is configured to open a capture queue to the Kernel driver and receive the loop back workload. This workload is then written to a local file in the pcap Network capture file format.

In case of IPC traffic capture (using Shared Memory and semaphores), the Kernel capture driver (104B) is configured to capture Shared Memory and Semaphore related system calls using System call Hooking techniques and read the shared memory into a local buffer queue. This queue is also simultaneously read by a Memory Mapped capture application which will write the captured data in the pcap Network capture file format. The user space application writing the captured data to disk will try to optimize disk writes by writing data in chunks.

Multiple Captures can also be initiated if it is not feasible to capture from one source only. The Capture device is Protocol Independent. The same Capture device can capture traffic from a variety of Databases such as Sybase™, DB2™, Informix™, etc.

The Capture device records the entire TCP/IP transactions across multiple TCP Sessions. The captured data may not be completely time sorted. Also, in case of larger throughputs, the capture may have some packet drops.

The IO capture process groups the captured workload into one or more chunks and periodically sends it to the next stage. The next stage involves ‘TCP Reordering’ (210) of the workload on the Replay machine (107). The Replay subsystem could either be the same machine used for the ‘IO Capture’ or a different machine, in which case the captured chunks are continuously sent to the new machine.

### ‘TCP Reordering’ (210) of the Captured Workload

The next stage is the TCP reorder stage (210) wherein the captured chunks are reordered. The TCP reordering subsystem (105) commences the reordering of the captured chunks after expiry of a first predetermined time period. The TCP reordering subsystem (105) begins reading and reordering of chunks of data after a time difference of say for example, ‘T1/3’ where ‘T1’ is the initial fixed time offset for the Replay subsystem (107) and continuously performs the reading and reordering of the chunks thus received from the IO capture stage (200).

In one embodiment, Network capture of the production server workload may result in TCP reorders whereby the capture device may have captured the response packet from the server prior to the original request packet from the client if the time difference between the request and response packet was miniscule. In such cases, reordering of the captured workload i.e., the transactions is performed to result in workload chunks which are time aligned and TCP aligned. In an aspect where multiple ‘IO Capture’ subsystems were involved in capturing the Source Production workload, the ‘TCP Reordering’ subsystem will also merge the different chunks created by each individual ‘IO Capture’ subsystem.

At block (212), the TCP Reorder engine will wait and receive the captured data. In one embodiment, the TCP reordering subsystem (104) waits for a particular time period as configured and reads the chunks of the data from the Production workload.

At block (214), it is determined as to whether there are any requirements of TCP reordering or TCP alignment. In one embodiment, if it is determined that the captured data requires TCP reorders, then the method proceeds to block (216) (i.e., “YES” path). In case of TCP reorders, the Sequence numbers would be out of order, wherein, a higher sequence number would be present before a lower sequence number. For TCP Packet Drops, a portion of sequence numbers (equal to the bytes missing) would be missing from the workload. In another embodiment, if it is determined that the captured data do not require TCP reorders, then the method proceeds to block (218) (i.e., “NO” path).

At block (216), the TCP packets are reordered in real time. In one embodiment, if it is determined that the captured data requires TCP reorder and TCP alignment i.e., “YES” path, then the reordering of the packets takes place. In one embodiment, the TCP reordering subsystem (104) amalgamates the chunks of packets from various ‘IO Capture’ processes based on packet timestamps and creates new round robin chunks of packets which are time aligned and TCP aligned.

In one embodiment, the TCP alignment is performed using the concept of TCP Sequence numbers. Each TCP packet has a Sequence Number associated with the packet to indicate the number of bytes associated with that connection from the start of the connection. Using TCP Sequence numbers, TCP reorders as well as TCP Packet Drops can be identified. The ‘TCP Reordering subsystem (105) will create a new consolidated TCP Reordered workload chunk containing TCP reordered transactions to be used for subsequent Pre-Processing, Replay and Analytics.

The TCP reordering needs to be heavily optimized so as not to delay the subsequent real time replay. The output rate of the TCP Reordering needs to be higher than the input rate so as not to introduce delays during the replay. For example, if the TCP Reordering subsystem, reads in 20 Mbytes/sec of captured workload, it should be able to write a TCP Reordered output file with at least the same rate (20 Mbytes/sec). The reordered file contains new round robin chunks of data which are time aligned and TCP aligned.

At block (218), the method proceeds to the next stage i.e., the Preprocessor stage (220) upon reordering the transactions. In one embodiment, if it is determined that the TCP reordering is not required to be performed on the captured data, then the method proceeds through “NO” path to signal the preprocessing subsystem and to initiate the preprocessor stage (220). In another embodiment, the method proceeds from block (216) on completion of reordering of the TCP packets to the block (218) for triggering the preprocessor stage (220).

### Pre-Processing (220) of the TCP Reordered Captured Chunks

The next stage, Pre-Processor (220) involves taking in User Specified Replay Configuration Parameters and creating Data Structures to be used for subsequent replays. The Pre-Processing engine (105) is initially provided a User Specified Replay Configuration Parameters. It reads in the chunks output from the ‘TCP Reorder’ engine and creates round robin Data Structures to be used for the Replay Engine. The engine is started at time difference for example, (2*‘T1’)/3, where ‘T1’ is the initial fixed time offset for the Replay engine. This stage requires in-depth knowledge of the Transport Protocol used by the database client-server communication. The Pre-Processing needs to be heavily optimized so as not to delay the subsequent real time replay.

At block (222), the reordered data is received after waiting for the same. In one embodiment, the preprocessing subsystem (106) waits for until the expiry of a predetermined period of time to receive the reordered data from the TCP reordering subsystem (105) and further to begin the preprocessing process.

At block (224), the reordered data thus received is analyzed based on different configuration options. In one embodiment, the options include: Target Server IP/Ports, Target server user passwords, Session Level Filters, Target Server Service Name, SSL Replay Session Level Filters, and Query Level Filters etc. This stage requires in-depth knowledge of the Transport Protocol used by the database client-server TCP communication. Target Server IP/Ports as input are needed since the Test Server to be used for the replay may be different from the Source Production Server. Target server user passwords as input are needed since; the Test server passwords may need to be set by an administrator and not by individual users

In one embodiment, if Session Level Filters are enabled, such as Filters based on Client username, Application Name, IP addresses, such sessions matching the filters are excluded from the replay.

In one embodiment, if SSL Replay Session Level Filters are enabled, individual sessions matching the filters would be SSL encrypted during the Replay. These sessions need not have been SSL encrypted during the Source run.

In one embodiment, if Query Level Filters are set, specific SQLs matching the filters may be skipped or modified, configured, during the Replay.

At block (226), dropped packets are detected. In one embodiment, the Pre-Processor stage (220) also checks for the validity of the capture as too many dropped packets may result in that particular TCP session being removed from the Replay list.

At block (228), commit dependant transactions are determined. In one embodiment, the Pre-Processor stage (220) is configured to detect potential Database Commit Dependent Transactions for a finer Inter Session Synchronization handling during the Replay phase. The Pre-Processing subsystem (106) is configured to determine transactions across multiple sessions which are
Started within a few milliseconds of each other.
Where the Server response of one transaction is seen after a ‘Commit Response’ of another transaction of some other session. In other words, the Server response to one of the requests came in only after a Commit was sent from another session and the Commit was responded to. The use of Commit is because after a commit, locks held by that client connection would be released.

Using such Potential Commit Dependent Transactions, the Replay subsystem (107) may schedule queries across multiple sessions which may be time misaligned as well. This may be used for queries which were seen very close to each other during the Original Workload.

At block 229A, valid packet offsets are written into round robin offsets files for the preprocessed chunks. In one embodiment, the preprocessed transactions are written into valid packets with offsets being written onto offset files thereby generating preprocessed transactions compatible for replaying.

At block 229B, the replay stage is initiated. In one embodiment, the preprocessing subsystem 106 preprocesses the round robin chunks of data into transactions compatible for replaying. Such preprocessed transactions are then replayed in the replay stage (230).

The preprocessor stage (220), however, is repeated continuously such that replaying begins after the expiry of predetermined time period say ‘T1’ seconds from the time of capturing the packets.

### Replay (230) of the Captured Workload

After Pre-Processing signals that chunks are available for Replay, the replay stage (230) can be initiated. The ‘Replay stage (230) is started at time offset ‘T1’ from the start of the Capture, where ‘T1’ is the initial configured Time Offset. The Replay subsystem (107) takes in as input the round robin chunks of packets outputted by the ‘TCP Reorder’ engine as well as the Offset information outputted by the ‘Pre-Processing’ engine.

Before the replay of the first chunk is started, the Target Test Database is restarted and restored with username passwords changed as per the password list provided in the Pre-Processing configuration. If the Original Workload contains Time Dependent Queries, the Test database machine local time may be changed to the same time.

The Test Database can have differences compared to the Original Database configuration. The Test Database can be of a higher version (for tests related to Database Upgrades) or it may have differences in configuration, for e.g. to test out Index changes. The Test Database may be on a box with a different hardware &/or Processor configuration or with a different OS. The only restriction being that the Test Database needs to be of the same database protocol as the original (for e.g. Sybase™ ASE to Sybase™ ASE).

To compare the Replay Workload to the Original workload by the ‘Reporting’ subsystem, the ‘IO Capture’ of the Replay Workload needs to be initiated. The Replay ‘IO capture’ can either be started directly on the Replay Server box or on the Test Database box.

At blocks (232, 234), the preprocessed valid packet offsets and valid packets are received from the preprocessor stage (220) and checked for its validity. In one embodiment, the Replay process (230) uses the preprocessed round robin chunks and Data structures as input. The Replay process fires TCP socket level communication messages to the Test Database using the raw Network Capture information available in the captured chunks. In other words, the Replay process extracts the TCP payload data from the Network Capture Frame and replays that payload using TCP socket send system calls.

There may be one or more Replay processes on the same Replay box connecting to the Target Test Server. Each Replay process may be multi-threaded with each thread handling one or more concurrent client sessions. Thus a single Replay box, with one or more Replay processes, is sufficient to fire the entire Production Level Traffic onto a Test System. The Replay process does not link with any Database Client Libraries and uses Database Transport Protocol knowledge instead.

At block 236, the TCP payload is subjected or replayed at the target database server. In one embodiment, the Replay subsystem receives the transactions and subjects the Test Server to the same workload/transactions as was originally fired. The target server would have no knowledge of the Replay being fired as the input queries to the target server are in the same format as was present in the original workload. To the target Server, it would appear that the input traffic is coming from the same Logins, Client Applications, and Client Libraries as were seen in the Original Production Workload. The Captured workload may contain SQL, non-SQL, background process, User Defined Types as supported by various Databases.

The Replay subsystem (107) fires queries to the Test Database with the same delay between two adjoining queries as was seen in the original workload so as to maintain near real time replay configuration. But the near real time replay configuration also depends on the Test database response times. If the test database is slower compared to the Production database, the replay may start to get delayed compared to the Production traffic.

The Replay subsystem (107) needs to have in-depth knowledge of the Transport Protocol (using TCP/IP) used by the Databases supported. The Replay subsystem also needs to know various Transport Protocol versions used by a specific Database such as TDS versions 4 and 5 for Sybase ASE, DRDA and SQLI for Informix.

In the replay stage (230), remapping of the configuration of the target database server with that of the source database server is performed by the remapping component 107A.

In one embodiment, the Replay subsystem substitutes the password seen for each Original Workload Client session Login with the new password configured. In another embodiment, the Replay subsystem stores a mapping of the Target Server Capabilities returned from the Login Response with the Source Server Login Capabilities. This may be used for protocol related substitution, for e.g. there may be differences in packets sizes negotiated during the replay compared to the source, or there could be different capabilities available in the Target compared to the Source.

In yet another embodiment, the Replay subsystem may also need to substitute the Original Server Service Name with the user configured Service Name during authentication. The Replay subsystem may create a mapping of SQL cursor IDs. A cursor ID may be returned by the Database server as a SQL identifier. The Replay subsystem may use this mapping to substitute the original workload cursor number while replaying. The Replay subsystem may also create a mapping of Large Object (LOB) descriptors. These descriptors may be part of Server Responses and may be re-used later by Client Sessions.

In still another embodiment, the Replay subsystem may also create a mapping of ROWIDs returned by the Target compared to the source. The Replay subsystem may track the Processor configuration of the Target and the Original Database machines. This may be used for swapping specific fields while sending Requests to the Target server. As an example, if the Original Database processor was Little-endian and the Replay Database processor is Big-endian, fields such as Token lengths, Token values, and cursor numbers may need to be byte-swapped.

Further, the Replay subsystem may also keep track of Test Server responses to SQLs such as Cursor Opens, Dynamic SQL Execution for errors, so that in case of Errors, subsequent SQLs within that particular client session referencing that particular cursor or Dynamic SQL may be skipped. In one aspect, the Replay subsystem may also keep track of Dropped bytes so that if the Dropped bytes could not be handled gracefully, that particular SQL request may be skipped. In another aspect, the Replay subsystem may also keep track of Sequence Numbers and in the event of skipped Requests due to Dropped bytes may change the Sequence numbers accordingly.

In yet another aspect, the Replay subsystem may keep track of the Original and Target Database versions as version changes may require changes to Request formats. In still another aspect, the Replay subsystem may need to keep track of Cursor Fetches returning different rows during the Replay compared to the Original in which case appropriate action needs to be undertaken. For example, if the result of a Cursor Fetch during the Replay indicates End of Response with all rows returned, but in the original workload there are subsequent Cursor Fetches still occurring, then during the replay, such Cursor Fetches need to be ignored. Further, the Replay subsystem may need to keep track of the Character Encoding used by the Test Server as well as the Original Server and change Requests accordingly. The Replay subsystem may need to save the Response of the Database Server to a ‘Describe’ SQL query and may need to have a mapping of the Original workload Describe statement to the Target.

All such substitutions done during the replay may be referred to collectively as ‘Replay Re-Mapping’. This ‘Replay Re-Mapping’ happens in real-time during the replay. This re-mapping is needed to ensure the correctness of the Replay.

The Replay subsystem may also keep track of TCP Fragmentation in the Source workload. TCP Fragmentation refers to the splitting of a single Application Layer PDU into multiple TCP packets due to size restrictions. The Replay subsystem needs to reassemble multiple TCP Fragments and send Requests to the Test Server as a complete PDU (after reassembling and after Replay Mapping). In one aspect, if SSL Replay was configured during the pre-processing, the Replay subsystem will SSL encrypt the sessions matching the filters configured.

Further, the Replay subsystem (107) also attempts to load-balance sessions amongst multiple target Listeners if more than one Target Listener IP/Port was configured. Target Listener implies the Target Database Server IP/Port. This could be beneficial in case of Replay to a cluster.

In addition, the Replay subsystem (107) also keeps track of Server Response times of the queries being replayed. If any query sent during the replay has not been responded to by the server within acceptable time differences compared to that query Response time seen during the Original pcap, the Replay subsystem will fire a new trigger query to the Target Database requesting information such as Lock Status, IO status, Query Plan for that executing SQL. The information thus retrieved from the Target Server will be stored and will be available during the Report Generation.

Also, the Replay subsystem is configured to reconcile Character set differences during the replay of Mainframe database transactions onto a Non-Mainframe machine.

### Maintaining Transactional Consistency Using Inter Session Synchronization

Real World Database Traffic under most circumstances has Inter Session Dependencies. This implies that the Server Response to a SQL from one client session may have dependency on a preceding Request from some other client session. As an example, one client session may fire a ‘Create Table creditcardinfo’ query and after some finite time thereafter, another client session may fire a ‘Insert into creditcardinfo’ query. If during the replay, the second query is fired before the first, it would result in an error as the ‘creditcardinfo’ table has not yet been created. As another example, the Order of inserts into a Table may have significance (such as in the case of a Trigger defined). Thus during the Replay the order of inserts would need to be maintained as in the original workload.

The Replay subsystem (107) will fire queries to the Test Server in the proper sequence as was seen in the Original Workload. The sequence is decided on the basis of Timestamps present in the Original Workload pcap, the order of packets present in the pcap and using Commit Dependency Tracking output from Pre-Processing stage.

Using the Pre-Processing Commit Dependency tracking, the Replay scheduler (107B) will re-schedule some transactions even though their Packet Timestamps may not be in the same order. The scheduled transactions will have dependent preceding transactions listed. The session handler thread within the Replay subsystem handling individual sessions will check the dependent preceding transaction before sending out the Request to the Test Server. If the session handler detects that the preceding transaction has not been processed yet, it will block waiting for a signal from the preceding transaction handling thread. In this way, transactional sequence is maintained.

The level of Transactional Consistency offered by using this approach is very high, but it is not 100%. For a complete 100% Transactional Consistency, the only way would be to track transactions using Database internal Transaction Sequence numbers which are only available within the database process internally but are not exposed during IO Capture. But using the approach listed above should suffice for most practical workloads. Even after sending Requests in order of Transactions during the Replay, the Test Server may respond to queries in a different order compared to the Original Workload. The Replay scheduler will detect such out-of-order responses and re-schedule subsequent transactions based on the out-of-order response.

The replay subsystem (107) periodically clean up the chunks of packets created by the TCP reordering subsystem (105) as well as the ‘preprocessing offset files’ generated by the preprocessing subsystem (106) so as to maintain a round robin disk usage.

### Replay Analytics and Reporting

During the replay, ‘IO Capture’ of the Replay may be started so as to capture the Replay workload. The Reporting system takes in as input files in Network pcap files (the Original Production Workload chunks). It also is capable of real time Network SQL capture monitoring and captures in real time the Replay SQL traffic. It later provides database SQL Level Performance Reports with comparative Summary Reports.

In one embodiment, the Reporting subsystem will analyze both the Original TCP Aligned pcap file and the Replay pcap file and generate comprehensive analytics for comparison. The comparative report may be generated which can show the Replay summary comparison as well as SQL to SQL comparison and Return Data Divergence between the Original and Replay runs. The reports include comparison of SQLs after stripping off all dynamic parameters such as Username, field values, etc.

For SQLs wherein the Replay subsystem fired extra information queries to the Target Server for slower running queries, the Reporting subsystem will include the results of information obtained from such queries such as Lock Status, IO status, Query Plans.

Further, the method may be implemented, for example, by operating portion(s) of the system to execute a sequence of machine-readable instructions. The instructions can reside in various types of signal-bearing or data storage primary, secondary or tertiary media. The media may comprise, for example, RAM accessible by, or residing within, the components of the system. Whether contained in RAM, a diskette, or other secondary storage media, the instructions may be stored on a variety of machine-readable data storage media, such as RAM memory, flash memory, ROM memory, EPROM memory, EEPROM memory, registers, hard disk, a removable disk, a CD-ROM, or any other form of physical storage medium known in the art. An exemplary storage medium is coupled to the processor such that the processor can read information from, and write information to, the storage medium. In the alternative, the storage medium may be integral to the processor.

The foregoing detailed description has described only a few of the many possible implementations of the present invention.

The above description is given only by way of illustration and nothing contained in this section should be construed to limit the scope of the invention.

What is claimed is:

1. A method for generating database transactions compatible for real time replaying of the transactions, said method comprising:
a. capturing transactions occurring with respect to a source database server in the form of data packets transmitted to/received there from;
b. grouping the data packets thus captured into one or more chunks;
c. creating new round robin chunks from the one or more chunks of step (b), wherein new round robin chunks thus created contain packets that are time aligned and TCP aligned; and
d. preprocessing the new round robin chunks of step (c) to generate database transactions compatible for real time replaying, said preprocessing is being performed based upon multiple configuration parameters selected from a group comprising Target server IP/Ports, Target server user passwords, Session Level Filters, Target Server Service Name, SSL Replay Session Level Filters, and Query Level Filters and database commit dependency.

2. The method as claimed in claim 1, wherein the step of creating new round robin chunks commences after the expiry of a first predetermined time period.

3. The method as claimed in claim 1, wherein the preprocessing of the newly created round robin chunks commences after the expiry of a second predetermined time period.

4. The method as claimed in claim 1, further comprising cyclically performing the step of grouping the data packets such that the step of creating new round robin chunks commences after the expiry of a third predetermined time period.

5. The method as claimed in claim 1, further comprising cyclically performing the step of creating new round robin chunks such that the step of preprocessing of the round robin chunks commences after the expiry of the third predetermined time period.

6. The method as claimed in claim 1, further comprising cyclically performing the step of preprocessing of the round robin chunks as and when new round robin chunks are created.

7. A method for real time replaying of database transactions, said method comprising:
re-mapping configuration and run time parameters of a target database server with the respective parameters of a source database server, said parameters include but not limited to Server capabilities, Login password, Server service name, SQL cursor IDs, Large Object (LOB) descriptors, ROWIDs; and
reading and replaying chunks of preprocessed database transactions onto the target database server, wherein the said database transactions thus read and replayed are based on database transactions that occurred on the source database server and that have been grouped into chunks and then reordered based on TCP header/footer information and pre-processed based on multiple configuration parameters selected from a group comprising Target server IP/Ports, Target server user passwords, Session Level Filters, Target Server Service Name, SSL Replay Session Level Filters, and Query Level Filters and database commit dependency.

8. The method as claimed in claim 7, wherein the replaying of the preprocessed database transactions commences after the expiry of a fourth predetermined time period.

9. A method for real time replaying of database transactions, said method comprising:
a. capturing transactions occurring with respect to a source database server in the form of data packets transmitted to/received there from;
b. grouping the data packets thus captured into one or more chunks;
c. creating new round robin chunks from the one or more chunks of step (b), wherein new round robin chunks thus created contain packets that are time aligned and TCP aligned; and
d. preprocessing the new round robin chunks of step (c) to generate database transactions compatible for real time replaying; and
e. receiving the preprocessed transactions and replaying the transactions thus received onto a target database server;
wherein the transactions thus captured and grouped into chunks are reordered based on TCP header/footer information; wherein the newly created round robin chunks are pre-processed based on multiple parameters selected from a group comprising Target server IP/Ports, Target server user passwords, Session Level Filters, Target Server Service Name, SSL Replay Session Level Filters, and Query Level Filters and database commit dependency to obtain transactions compatible for real time replaying.

10. The method as claimed in claim 9, wherein the step of creating new round robin chunks commences after the expiry of a first predetermined time period.

11. The method as claimed in claim 9, wherein the preprocessing of the newly created round robin chunks commences after the expiry of a second predetermined time period.

12. The method as claimed in claim 9, further comprising cyclically performing the step of grouping the data packets such that the step of creating new round robin chunks commences after the expiry of a third predetermined time period.

13. The method as claimed in claim 9, further comprising cyclically performing the step of creating new round robin chunks such that the step of preprocessing of the round robin chunks commences after the expiry of the third predetermined time period.

14. The method as claimed in claim 9, further comprising cyclically performing the step of preprocessing of the round robin chunks as and when new round robin chunks are created.

15. The method as claimed in claim 9, wherein the replaying of the preprocessed database transactions commences after the expiry of a fourth predetermined time period.

16. The method as claimed in claim 9, further comprising:
a. monitoring the performance of the target database server; and
b. generating reports based on the comparison of performance of the source database server with the target database server.

17. A system for generating database transactions compatible for real time replaying of the transactions, said system comprising:
a. an IO capturing sub-system, communicatively coupled with a source database server and being configured to
capture transactions occurring with respect to a source database server in the form of data packets transmitted to/received there from; and
group the data packets thus captured into one or more chunks;
b. a TCP reordering sub-system, communicatively coupled with the IO capturing sub-system and being configured to create new round robin chunks from the one or more chunks created by the IO capturing sub-system, wherein new round robin chunks thus created contain packets that are time aligned and TCP aligned; and
c. a pre-processing sub-system, communicatively coupled with the TCP reordering sub-system and being configured to preprocess the new round robin chunks thus created by the TCP reordering sub-system to generate database transactions compatible for real time replaying, said preprocessing is being performed based upon multiple configuration parameters selected from a group comprising Target server IP/Ports, Target server user passwords, Session Level Filters, Target Server Service Name, SSL Replay Session Level Filters, and Query Level Filters and database commit dependency.

18. The system as claimed in claim 17, wherein the TCP reordering sub-system is configured to commence the creation of new round robin chunks after the expiry of a first predetermined time period.

19. The system as claimed in claim 17, wherein the pre-processing sub-system is configured to commence the preprocessing of the newly created round robin chunks after the expiry of a second predetermined time period.

20. The system as claimed in claim 17, wherein the IO capturing sub-system is further configured to cyclically perform the step of grouping the data packets such that the TCP reordering sub-system commences the step of creating new round robin chunks after the expiry of a third predetermined time period.

21. The system as claimed in claim 17, wherein the TCP reordering sub-system is further configured to cyclically perform the step of creating new round robin chunks such that the pre-processing sub-system commences the preprocessing of the round robin chunks after the expiry of the third predetermined time period.

22. The system as claimed in claim 17, wherein the pre-processing sub-system is further configured to cyclically perform preprocessing of the round robin chunks as and when the TCP reordering sub-system creates new round robin chunks.

23. A system for real time replaying of database transactions, said system comprising:
a re-mapping component, being configured to remap configuration and run time parameters of a target database server with the respective parameters of a source database server, said parameters include but not limited to Server capabilities, Login password, Server service name, SQL cursor IDs, Large Object (LOB) descriptors, ROWIDs; and
a replay scheduler, being configured to read and replay chunks of preprocessed database transactions onto the target database server, wherein the said database transactions thus read and replayed by the replay scheduler are based on database transactions that occurred on the source database server and grouped into chunks by the IO capturing sub-system and that have been reordered by the TCP reordering sub-system based on TCP header/footer information and pre-processed by the pre-processing sub-system based on multiple configuration parameters selected from a group comprising Target server IP/Ports, Target server user passwords, Session Level Filters, Target Server Service Name, SSL Replay Session Level Filters, and Query Level Filters and database commit dependency.

24. The system as claimed in claim 23, wherein the replay scheduler is configured to commence the replaying of the preprocessed database transactions after the expiry of a fourth predetermined time period.

25. A system for real time replaying of database transactions of a source database server onto a target database server, said system comprising:
an IO capturing subsystem, communicatively coupled to the source database server and being configured capture transactions occurring with respect to a source database server in the form of data packets transmitted to/received there from and group the data packets thus captured into one or more chunks;
a TCP reordering sub-system, communicatively coupled with the IO capturing sub-system and being configured to create new round robin chunks from the one or more chunks created by the IO capturing sub-system, wherein new round robin chunks thus created contain packets that are time aligned and TCP aligned; and
a pre-processing sub-system, communicatively coupled with the TCP reordering sub-system and being configured to preprocess the new round robin chunks thus created by the TCP reordering sub-system to generate database transactions compatible for real time replaying; and
a replay subsystem, communicatively coupled to the target database server and being configured to receive the preprocessed chunks from the said pre-processing subsystem and replay the preprocessed chunks thus received in real time;
wherein the pre-processing sub-system is being configured to pre-process the newly created round robin chunks based on multiple parameters selected from a group comprising Target server IP/Ports, Target server user passwords, Session Level Filters, Target Server Service Name, SSL Replay Session Level Filters, and Query Level Filters and database commit dependency to obtain transactions compatible for real time replaying.

26. The system as claimed in claim 25, further comprising a Reporting subsystem configured to monitor the performance of the target database server and to generate a report based on comparison of the performance of the source database server and the target database server.

27. A computer-readable medium comprising instructions, which, when executed by a computer system, cause the system to perform operations, the instructions comprising:
a. capturing transactions occurring with respect to a source database server in the form of data packets transmitted to/received there from;
b. grouping the data packets thus captured into one or more chunks;
c. creating new round robin chunks from the one or more chunks of step (b), wherein new round robin chunks thus created contain packets that are time aligned and TCP aligned; and
d. preprocessing the new round robin chunks of step (c) to generate database transactions compatible for real time replaying, said preprocessing is being performed based upon multiple configuration parameters selected from a group comprising Target server IP/Ports, Target server user passwords, Session Level Filters, Target Server Service Name, SSL Replay Session Level Filters, and Query Level Filters and database commit dependency.

28. The computer readable medium as claimed in claim 27, wherein instructions for creating new round robin chunks comprises instructions for commencing creating of new round robin chunks after the expiry of a first predetermined time period.

29. The computer readable medium as claimed in claim 27, wherein instructions for preprocessing comprises instructions for commencing preprocessing of the newly created round robin chunks after the expiry of a second predetermined time period.

30. The computer readable medium as claimed in claim 27, further comprising instructions for cyclically performing the step of grouping the data packets such that the step of creating new round robin chunks commences after the expiry of a third predetermined time period.

31. The computer readable medium as claimed in claim 27, further comprising instructions for cyclically performing the step of creating new round robin chunks such that the step of preprocessing of the round robin chunks commences after the expiry of the third predetermined time period.

32. The computer readable medium as claimed in claim 27, further comprising instructions for cyclically performing the step of preprocessing of the round robin chunks as and when new round robin chunks are created.

33. A computer-readable medium comprising instructions, which, when executed by a computer system, cause the system to perform operations, the instructions comprising:
re-mapping configuration and run time parameters of a target database server with the respective parameters of a source database server, said parameters include but not limited to Server capabilities, Login password, Server service name, SQL cursor IDs, Large Object (LOB) descriptors, ROWIDs; and
reading and replaying chunks of preprocessed database transactions onto the target database server, wherein the said database transactions thus read and replayed are based on database transactions that occurred on the source database server and that have been grouped into chunks and then reordered based on TCP header/footer information and pre-processed based on multiple configuration parameters selected from a group comprising Target server IP/Ports, Target server user passwords, Session Level Filters, Target Server Service Name, SSL Replay Session Level Filters, and Query Level Filters and database commit dependency.

34. The computer readable medium as claimed in claim 33, wherein the instructions for replaying comprises instructions for replaying of the preprocessed database transactions commences after the expiry of a fourth predetermined time period.

35. A computer-readable medium comprising instructions, which, when executed by a computer system, cause the system to perform operations, the instructions comprising
a. capturing transactions occurring with respect to a source database server in the form of data packets transmitted to/received there from;
a. grouping the data packets thus captured into one or more chunks;
b. creating new round robin chunks from the one or more chunks of step (b), wherein new round robin chunks thus created contain packets that are time aligned and TCP aligned; and
c. preprocessing the new round robin chunks of step (c) to generate database transactions compatible for real time replaying; and
d. receiving the preprocessed transactions and replaying the transactions thus received onto a target database server;
wherein the transactions thus captured and grouped into chunks are reordered based on TCP header/footer information; wherein the newly created round robin chunks are pre-processed based on multiple parameters selected from a group comprising Target server IP/Ports, Target server user passwords, Session Level Filters, Target Server Service Name, SSL Replay Session Level Filters, and Query Level Filters and database commit dependency to obtain transactions compatible for real time replaying.

36. The computer readable medium as claimed in claim 35, wherein instructions for creating new round robin chunks comprises instructions for commencing creation of new round robin chunks after the expiry of a first predetermined time period.

37. The computer readable medium as claimed in claim 35, wherein instructions for preprocessing comprises instructions for commencing the preprocessing of the newly created round robin chunks after the expiry of a second predetermined time period.

38. The computer readable medium as claimed in claim 35, further comprising instructions for cyclically performing the step of grouping the data packets such that the step of creating new round robin chunks commences after the expiry of a third predetermined time period.

39. The computer readable medium as claimed in claim 35, further comprising instructions for cyclically performing the step of creating new round robin chunks such that the step of preprocessing of the round robin chunks commences after the expiry of the third predetermined time period.

40. The computer readable medium as claimed in claim 35, further comprising instructions for cyclically performing the step of preprocessing of the round robin chunks as and when new round robin chunks are created.

41. The computer readable medium as claimed in claim 35, wherein instructions for replaying comprising instructions for commencing the replaying of the preprocessed database transactions after the expiry of a fourth predetermined time period.

42. The computer readable medium as claimed in claim 35, further comprising instructions for:
a. monitoring the performance of the target database server; and
b. generating reports based on the comparison of performance of the source database server with the target database server.
